(19) United States
(12) Patent Application Publication
(10) Pub. No.: US 2012/0216638 A1
(43) Pub. Date: Aug. 30, 2012

(54) ELECTRIC VEHICLE THREE SPEED DUAL CLUTCH TRANSMISSION

(75) Inventors: Larry A. Pritchard, Macomb, MI (US); Matthew A. Rahaim, Royal Oak, MI (US); Mark R. Buchanan, Rochester Hills, MI (US)

(73) Assignee: BORGWARNER INC., Auburn Hills, MI (US)

(21) Appl. No.: 13/394,963

(22) PCT Filed: Sep. 8, 2010
(86) PCT No.: PCT/US10/48072

§ 371 Date: May 14, 2012

(30) Foreign Application Priority Data
Sep. 17, 2009 (US) 61276866
Feb. 1, 2010 (US) 61337221

(51) Int. Cl. F16H 3/08; F16D 13/38

(52) U.S. Cl. 74/329; 192/66.3

(57) ABSTRACT

A transmission and components thereof that consists of three forward speed ratios for an electric vehicle market is brought forth. The transmission has an input shaft for receiving torsional energy from an electric motor. A counter shaft is provided which is powered from the input shaft. A first normally closed clutch is provided for powering the first and third gears. A second normally open clutch is provided for powering the second gear. A synchronizer rotatably is provided for selectively torsionally connecting the first of third gears.

### CROSS-REFERENCE TO RELATED APPLICATIONS

This application claims the benefit of U.S. Provisional Application No. 61/276,866, filed Sep. 17, 2009 and U.S. Provisional Application No. 61/337,221, filed Feb. 1, 2010.

### FIELD OF THE INVENTION

The present invention relates to a transmission and component thereof that consists of three forward speed ratios for an electric vehicle market.

### BACKGROUND OF THE INVENTION

Dual clutch transmissions have been provided to give a vehicle the ease of operation typically associated with vehicles having an automatic transmission while at the same time providing the operational efficiencies most often associated with vehicles having a manually operated transmission. It is desirable to bring the advantages associated with dual clutch transmissions to electrically powered vehicles. Additionally, it is desirable to provide a dual clutch transmission which minimizes parasitic losses associated with fluid activated clutches provided for a typical dual clutch transmission.

### SUMMARY OF THE INVENTION

To make manifest the above noted and other manifold desires, a revelation of the present invention is brought forth. In a preferred embodiment, the present invention brings forth a dual clutch automotive vehicle transmission and component thereof. The transmission has an input shaft for receiving torsional energy from an electric motor. A counter shaft is provided which is powered from the input shaft. A first normally closed clutch is provided for powering the first and third gears. A second normally open clutch is provided for powering the second gear. A synchronizer is provided for selectively torsionally connecting the first or third gear with a shaft torsionally associated with an output shaft.

Other advantages of the present invention will be readily apparent to those skilled in the art as the invention is further revealed from the accompanying drawings and detailed description.

### BRIEF DESCRIPTION OF THE DRAWINGS

The present invention will become more fully understood from the detailed description and the accompanying drawings, wherein:

FIG. 1 is a schematic view of a dual clutch transmission of the present invention for an electric motor powered automotive vehicle;

FIG. 2 is a cross-sectional view of the transmission shown in FIG. 1;

FIG. 3 is an alternate preferred embodiment dual clutch transmission of the present invention;

FIG. 4 is another alternate preferred embodiment dual clutch transmission according to the present invention;

FIG. 5 is still yet another alternative preferred embodiment dual clutch transmission according to the present invention;

FIG. 6 is another alternate preferred embodiment dual clutch transmission according to the present invention;

FIG. 7 is another alternate preferred embodiment dual clutch transmission according to the present invention similar to that shown in FIG. 6, however, being for a rear wheel drive arrangement;

FIG. 8 is another alternate preferred embodiment dual clutch transmission according to the present invention for a rear wheel drive vehicle;

FIG. 9 is another alternate preferred embodiment dual clutch transmission according to the present invention for a rear wheel drive vehicle;

FIG. 10 is another alternate preferred embodiment dual clutch transmission according to the present invention for a rear wheel drive vehicle;

FIG. 11 is another alternate preferred embodiment dual clutch transmission according to the present invention for a rear wheel drive vehicle;

FIG. 12 is a front perspective view of a clutch housing for a clutch utilized in the dual clutch transmission shown in FIG. 11;

FIG. 13 is a rear perspective view of the dutch housing shown in FIG. 12;

FIG. 14 is a front elevational view of the clutch housing shown in FIG. 12;

FIG. 15 is a side elevational view of the clutch housing shown in

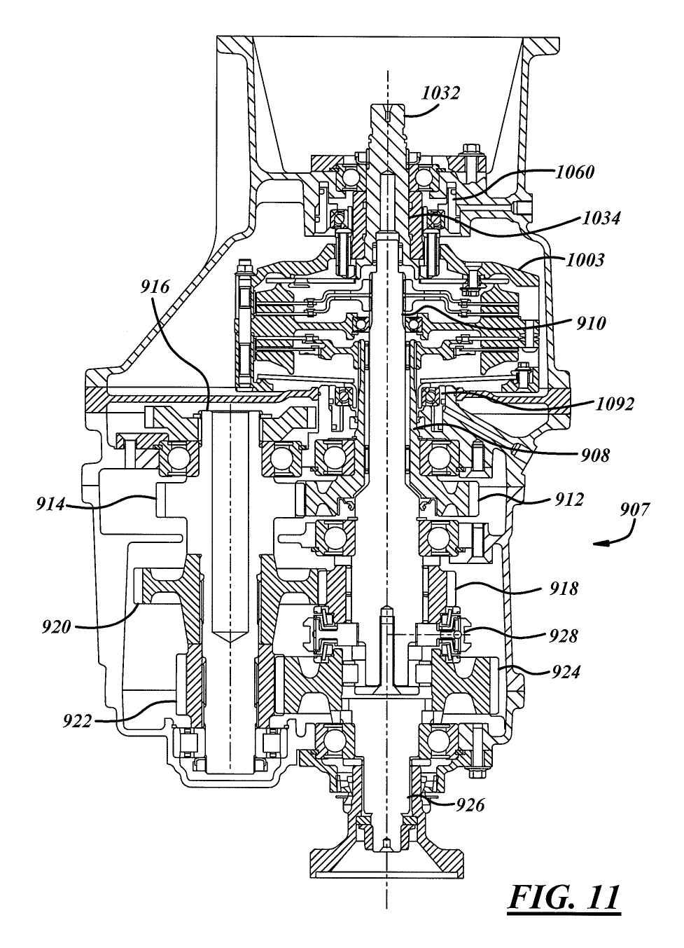

FIG. 11;

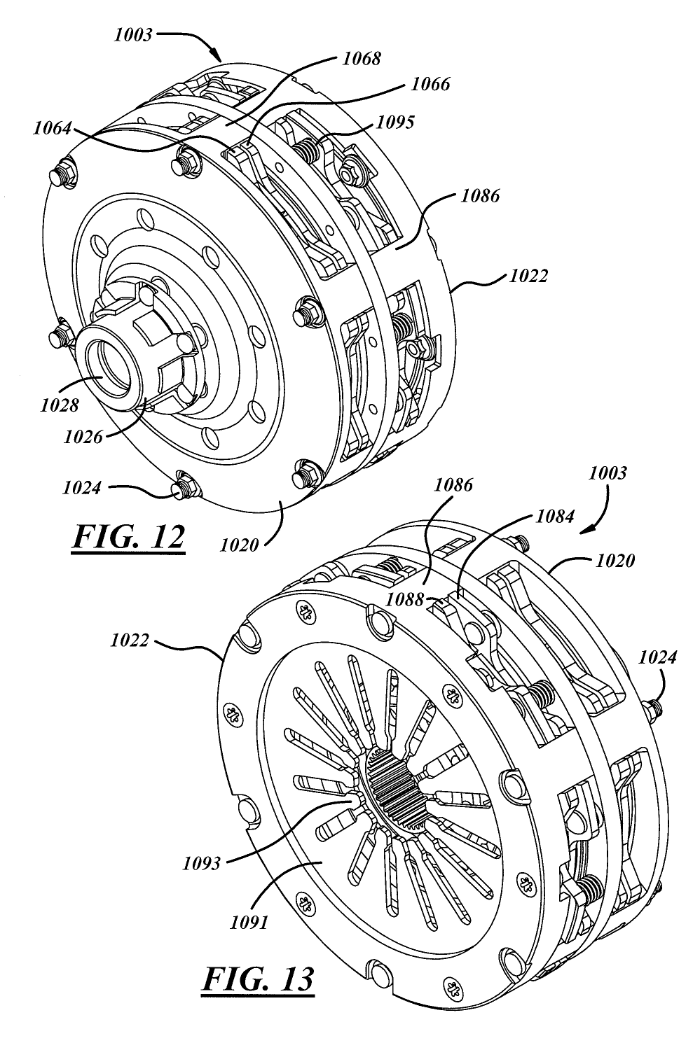

FIG. 16 is a sectional view of the clutch housing shown in FIGS. 12 and 17 taken along lines 16-16;

FIG. 17 is a rear elevational view of the clutch housing shown in FIG. 11;

FIG. 18 is a view taken along line 18-18 of FIG. 17; and

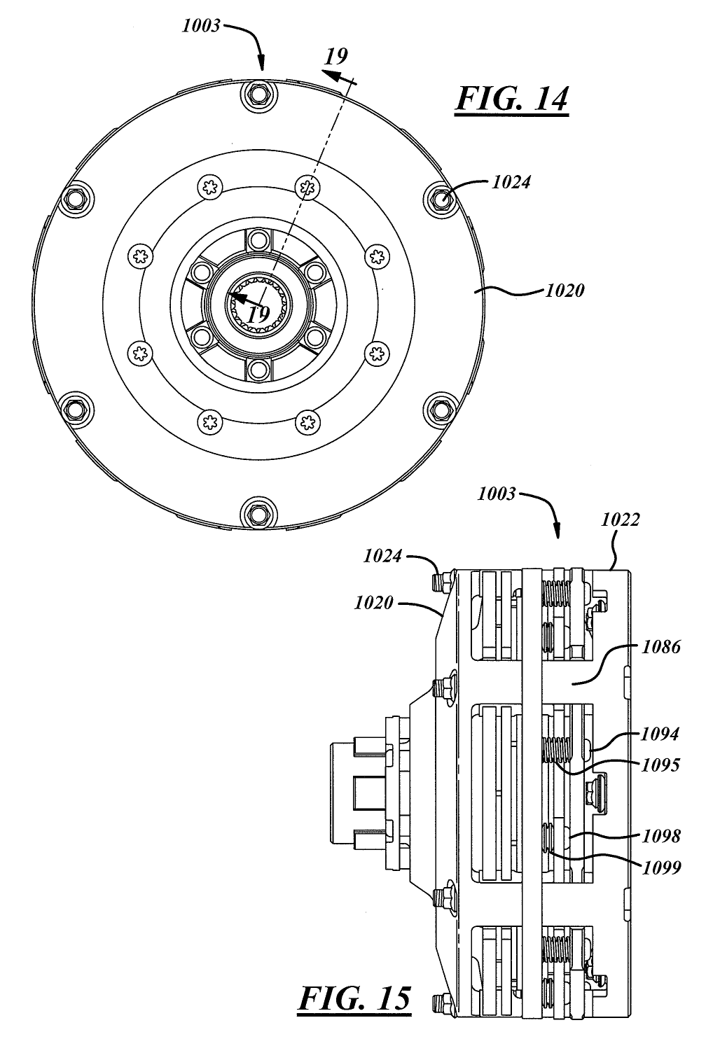

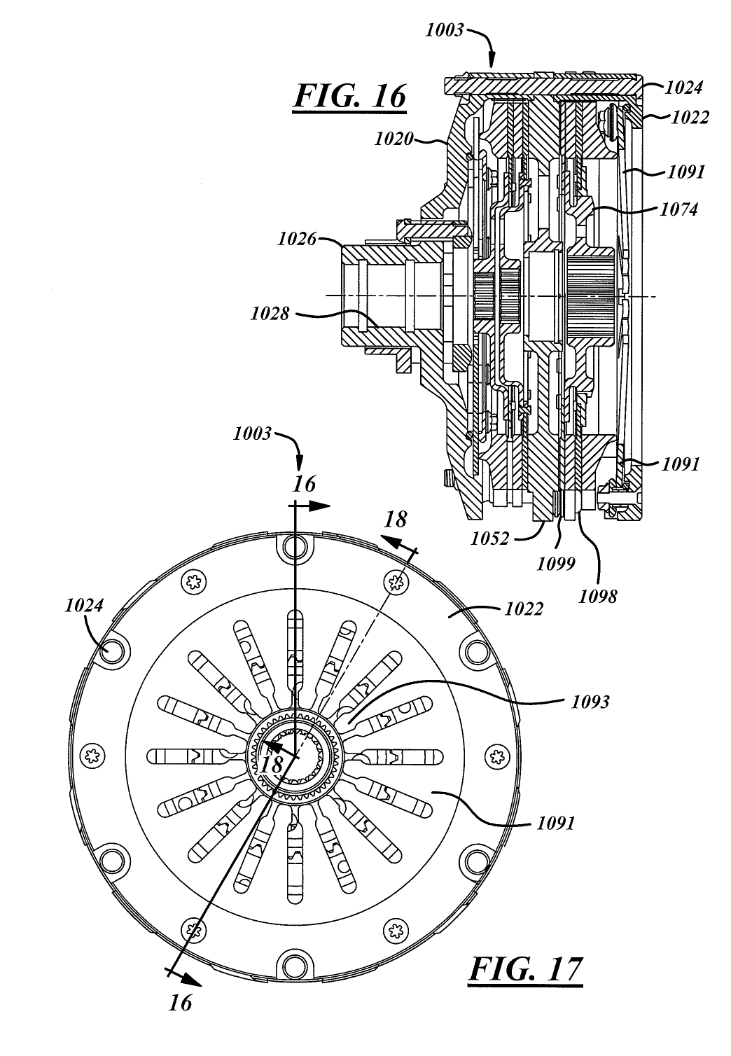

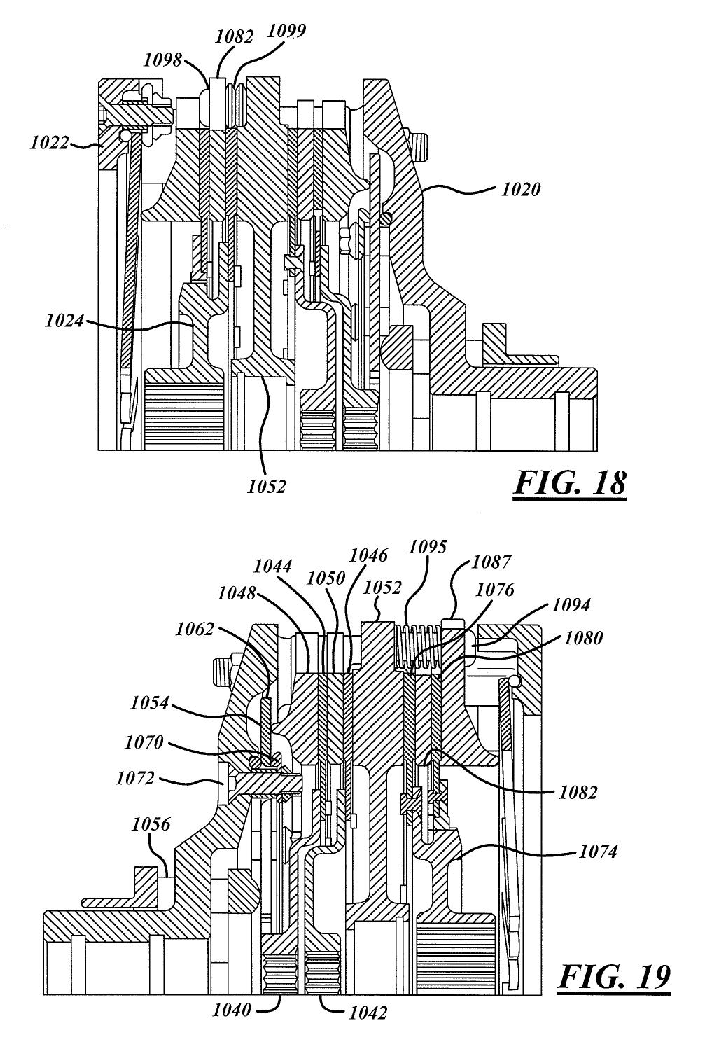

FIG. 19 is a view taken along lines 19-19 of FIG. 14.

### DETAILED DESCRIPTION OF THE PREFERRED EMBODIMENTS

The following description of the preferred embodiment(s) is merely exemplary in nature and is in no way intended to limit the invention, its application, or uses.

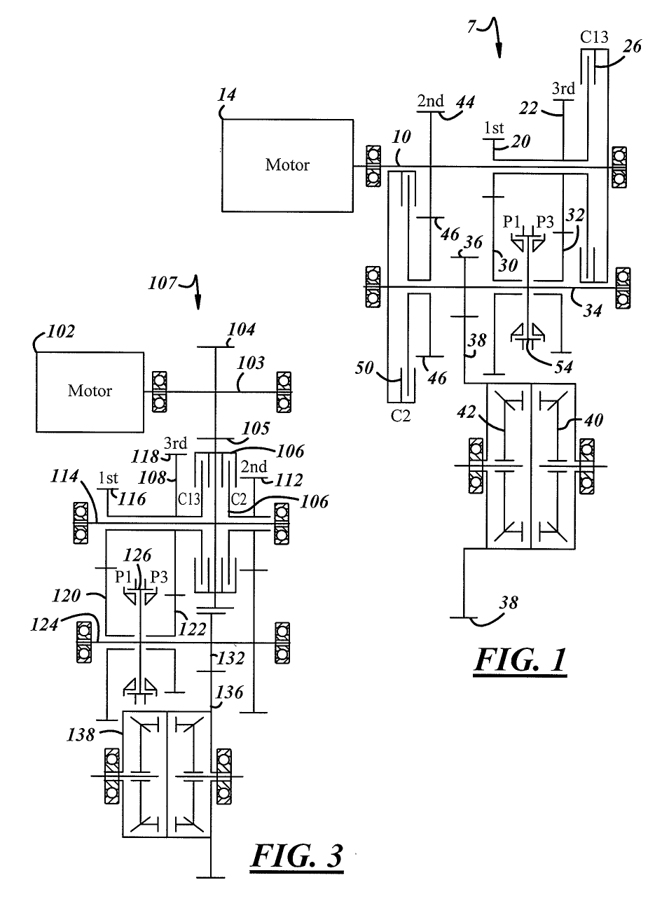

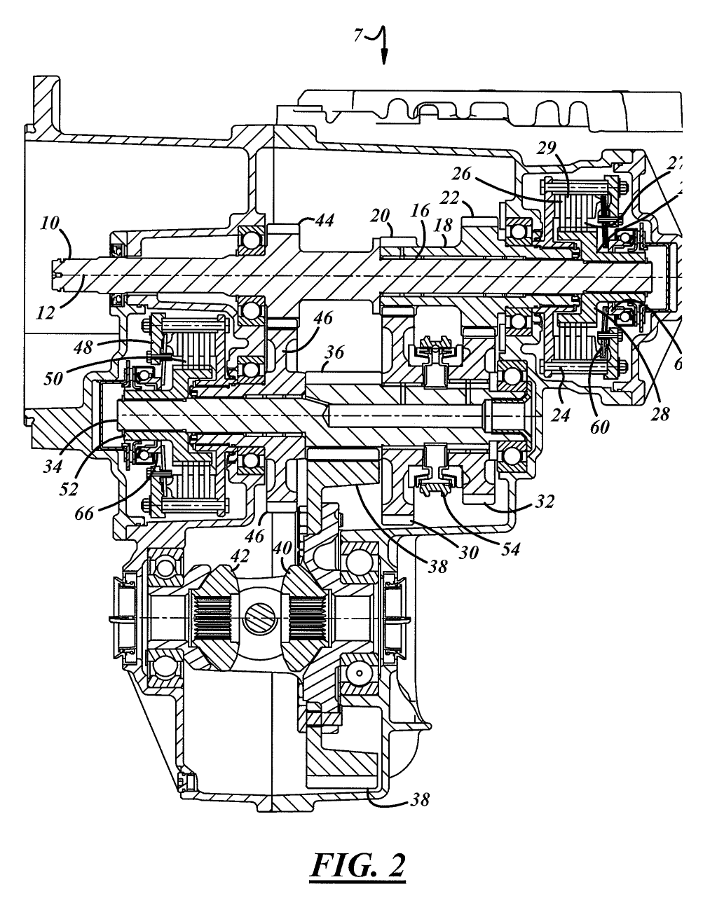

Referring to FIGS. 1 and 2, a dual clutch transmission 7 for an electrically powered vehicle is provided. Transmission 7 has an input shaft 10. The input shaft 10 rotates along an axis 12. The axis 12 is coterminous with the output axis of an electric motor 14 which powers the vehicle. Rotatably mounted on the input shaft 10 by a needle bearing 16 is an outer shaft 18. The outer shaft 18 has integrally formed therewith a first input gear 20 and a third input gear 22. Torsionally connected to the outer shaft 18 at its extreme end is a first/third gear clutch housing 24 which mounts a first friction pack 26. The first friction pack 26 has alternating friction discs 27 and separator plates 29. The separator plates 29 along their outer diameter are spline connected to the clutch housing 24. The friction discs 27 along their inner diameter are spline to a clutch hub 28. The first input gear 20 meshes with a first output gear 30. The third input gear 22 meshes with a third output gear 32. The output gears 30 and 32 are mounted by needle bearings on an output shaft 34. To torsionally connect the output shaft 34 with the remainder of the drive train of the vehicle, the output shaft 34 has an integral pinion output gear 36 that meshes with a differential input gear 38. Gear 38 is a ring gear which drives differential shaft output gears 40 and 42 which drives left and right and front drive shafts and wheels (not shown) of the vehicle or could also be used to drive the front and rear axle when installed in a longitudinal in an all-wheel drive configuration. (Note in FIG. 2, the input shaft, output shaft and differential are shown in a common plane for purposes of illustration only; in many applications, their axes are in different planes).

The input shaft 10 also has an integrally formed second input gear 44. The second input gear 44 meshes with a second output gear 46. The second output gear 46 is rotatably mounted on the output shaft 34 and can be torsionally connected with the output shaft 34 via a second gear clutch housing 48 which interacts with a friction pack 50 and an inner hub 52 which upon activation of the friction pack 50 torsionally connects the second output gear 46 with the output shaft 34. The friction pack 50 is on an extreme end of the output shaft opposite of friction pack 26.

A first third gear synchronizer 54 is provided for selectively connecting the first output gear 30 or the third output gear 32 with the output shaft 34.

The first third gear clutch which includes clutch housing 24, friction pack 26 and hub 28, has a spring member 60 which causes the friction pack 26 to be normally engaged (closed) thereby causing the outer shaft 18 to be torsionally connected with the input shaft 10 during normal stages of operation. A hydraulically powered actuator 63 upon activation causes the friction pack 26 to be released thereby opening the normally closed friction patch 26. In an opposite manner, the clutch for the second gear which includes clutch housing 48, friction pack 50 and hub 52 is biased to a normally open position unless acted upon by actuator 66 to engage the second friction pack 50 to connect the second output gear 46 with the output shaft 34. Releasing actuator 63, the friction pack 26 disconnects the outer shaft 18 from the input shaft 10. Thereafter or simultaneously the actuator 66 is actuated to engage the friction pack 50 to torsionally connect the second output gear 46 with the output shaft 34. Thereafter, torsional force flows from the input shaft 10 through second input gear 44 through second output gear 46 to the output shaft 34 and through the output gear 36 to the differential. To provide a parking brake function, all that is needed is the actuation of the second dutch friction pack 50 while the first dutch is left in its normally dosed state.

Referring to FIG. 3, an alternate preferred embodiment electric vehicle dual dutch transmission 107 is provided. Transmission 107 is powered by motor 102 powering a motor output shaft 103. Motorized output shaft 103 is torsionally connected with a gear 104. Gear 104 is in mesh with an input gear 105. Input gear 105 is torsionally connected with a double clutch housing 106. Double clutch housing 106 includes a normally closed first and third gear dry clutch 108 and a second normally open second gear clutch 110. The second gear clutch 110 when closed torsionally connects a second input gear 112 with an input shaft 114. The first and third gear clutch 108 connects a first input gear 116 and a third input gear 118 with the input shaft 114. The first input gear 116 and third input gear 118 mesh with first output gear 120 and third output gear 122 respectively. First output gear 120 or third output gear 122 are selectively torsionally connected with an output shaft 124 by the first third gear synchronizer 126. The second input gear 112 is meshed with the second output gear 128 that is torsionally affixed with the output shaft 124. The output shaft 124 has a pinion output gear 132 which is then meshed with the ring input gear 136 of the differential 138. As the same as with transmission 7, previously described, the first third gear clutch 108 is normally closed and the second gear clutch 110 is normally open. The transmission shifting logic for transmissions 107 is essentially identical to that previously described for transmission 7. An advantage of the transmission 107 over transmission 7 is that 1^{st}/3^{rd} clutch 108 of transmission 107 spins at a slower speed than in transmission 7 (friction pack 26). This may enable the use of a wet clutch instead of the dry clutch cited for friction pack 26.

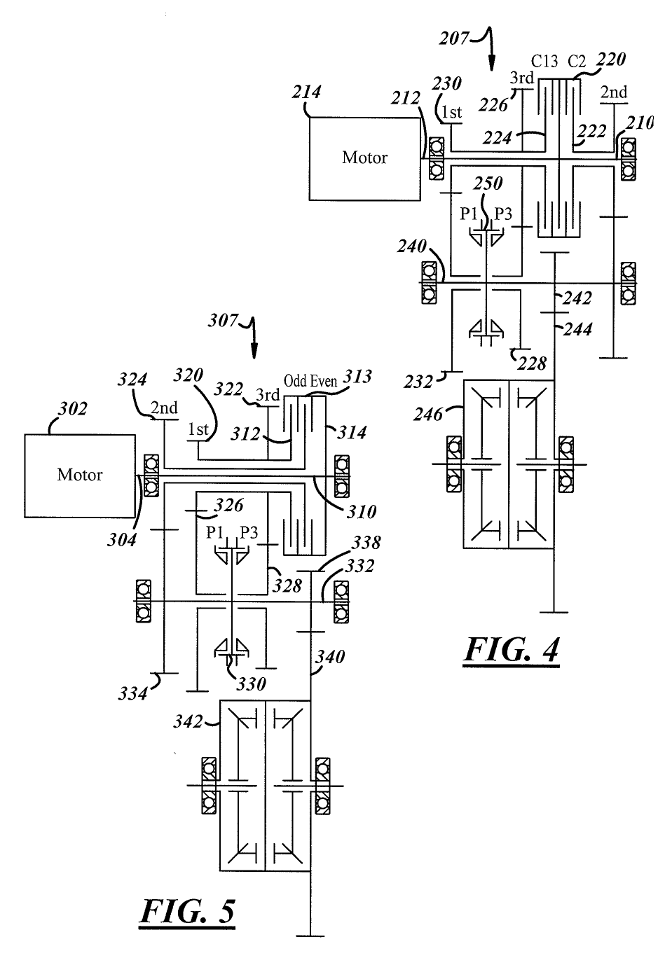

Referring to FIG. 4, an alternate preferred embodiment transmission 207 according to the present invention is provided. Dual clutch transmission 207 has an input shaft 210 that is axially coterminous with the output shaft 212 of a motor 214 powering the transmission. The input shaft 210 empowers a dual clutch housing 220 for a dry second gear normally open clutch 222 and a dry first and third gear normally closed clutch 224. A third input gear 226 meshes with a third output gear 228. A first input gear 230 meshes with a first output gear 232. A second input gear 234 meshes with a second output gear 236 which is torsionally fixably connected with an output shaft 240. The output shaft 240 is torsionally fixably connected with an output gear 242 which meshes with a differential ring input gear 244 for a differential 246. A first and third gear synchronizer 250 is provided to selectively connect first output gear 232 or third output gear 228 with the output shaft 240. The operation transmission 207 is essentially identical to those previously described transmissions 107 and 7. An advantage of transmission 207 over transmission 7 is that transmission 207's primary axial length is a more compact package than that of transmission 7. In transmission 207, the first, second and third gears are all on a common side of the combined first and second clutch housings 220.

Referring to FIG. 5, a dual clutch transmission embodiment 307 is provided having a motor 302 with an output shaft 304 having an axis coterminous with an input shaft 310 of transmission. Transmission 307 has a normally engaged first and third gear clutch 312 and a normally open second gear clutch 314 which share common clutch housing 313. First third gear clutch 312 drives a first input gear 320 and a third input gear 322. Second clutch 314 drives a second input gear 324. First input gear 320 meshes with first output gear 326. Third input gear 322 meshes with third output gear 328. A first third synchronizer 330 selectively connects the first output gear 326 or third output gear 328 with an output shaft 332. A second output gear 334 meshes with the second input gear 324. An output gear drive pinion 338 meshes with a differential ring input gear 340 which in turn drives a differential 342. The selection sequence for the operation of the clutches and the synchronizer for the transmission 307 are the same as those previously described for transmission 7, 107 and 207. An advantage of transmission 307 over transmission 7 is that transmission 307 has a shorter axial length.

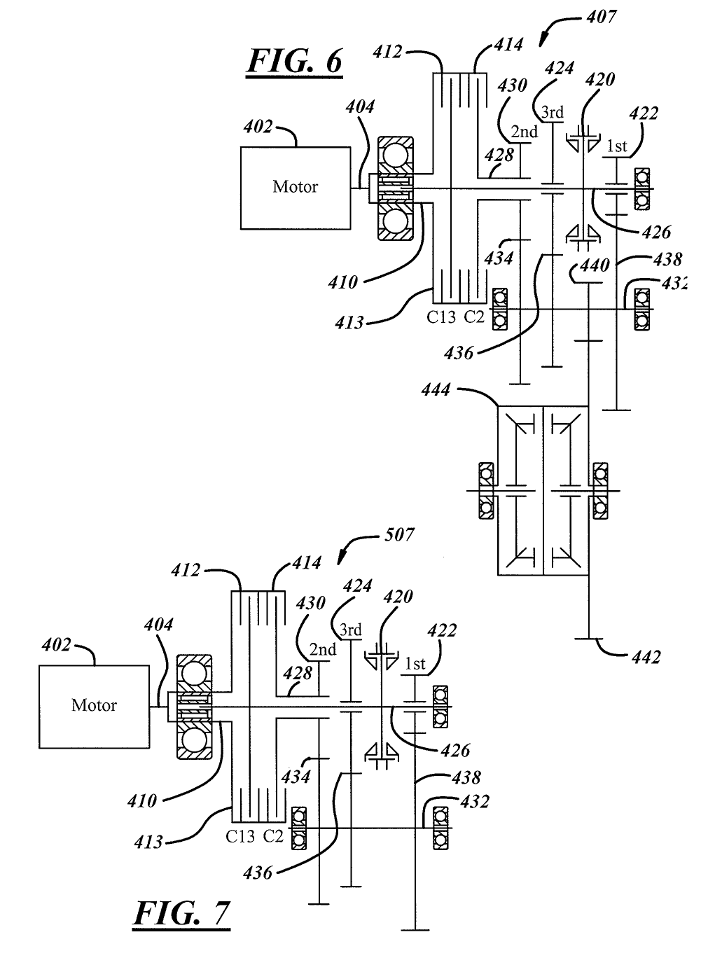

Referring to FIG. 6, a dual clutch transmission embodiment 407 is provided having a motor 402 with an output shaft 404 having an axis coterminous with an axis of an input shaft 410 of a dual clutch of the transmission. Transmission 407 has a normally engaged first and third gear clutch 412 and a normally open second gear clutch 414 which share common clutch housing 413. A first third gear synchronizer 420 is utilized to selectively connect a first input gear 422 or third input gear 424 to a transmission inner input shaft 426. The normally open second gear dutch 414 can selectively engage a transmission outer input shaft 428 to rotate a second input gear 430. A counter shaft output shaft 432 has torsionally connected therewith a second output gear 434, a third output gear 436 and a first output gear 438 which mesh with their respective input gears. An output pinion 440 provides a torsional connection of an input ring gear 442 of a differential 444. The selection sequence for the operation of the clutches and the synchronizer with the transmission 407 is the same of those previously described in transmission 7. Transmission 407 allows the synchronizer for the first and third gears to be placed on a shaft coterminous with the axis of the motor output shaft 404. Placing the synchronizer on the same axis as the input shaft allows the synchronizer to have a lower torsional capacity and thus less cost.

Transmission 507 provides an arrangement essentially identical to transmission 407 with the exception that transmission 507 does not have a pinion gear 440, but provides an output to a prop shaft (not shown) which is directly connected to the output or counter shaft 432 allowing the transmission 507 to utilize for rear wheel drive vehicles.

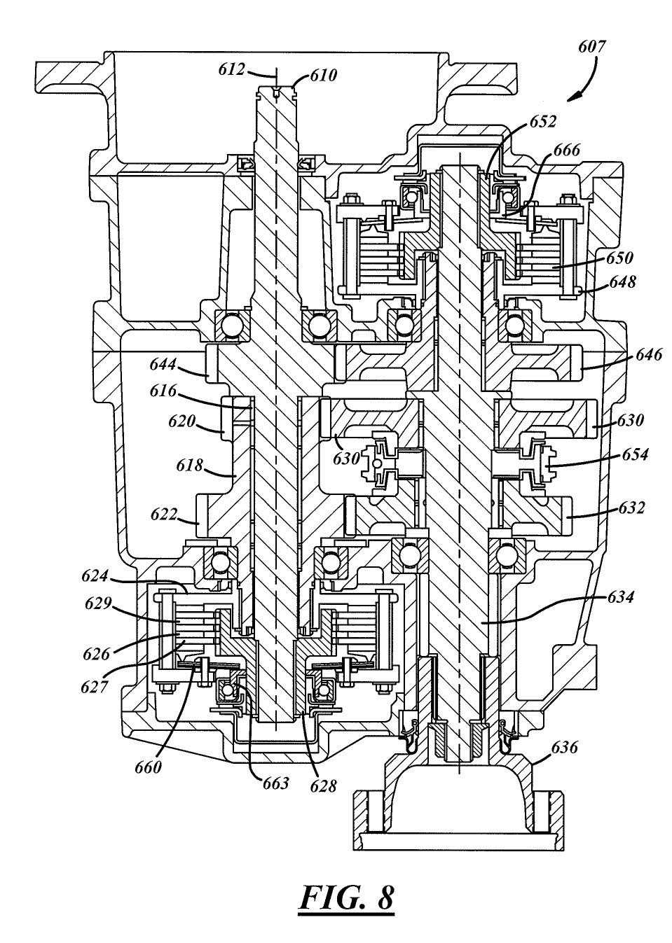

Referring to FIG. 8, a dual clutch transmission 607 for an electrically powered vehicle is provided. The transmission is for a vehicle with a parallel mounted motor (not shown). Typically, such vehicles are front end motor rear wheel drive vehicles. Transmission 607 has an input shaft 610. The input shaft 610 rotates along an axis 612. The axis 612 is coterminous with the output axis of an electric motor (not shown) which powers the vehicle. Rotatably mounted on the input shaft 610 by needle bearings 616 is an outer shaft 618. The outer shaft 618 has integrally formed therewith a first input gear 620 and a third input gear 622. Torsionally connected to the outer shaft 618 at its extreme end is a first/third gear clutch housing 624 which mounts a first dry friction pack 626. The first friction pack 626 has alternating friction discs 627 and separator plates 629. The separator plates 629 along their outer diameter are spline connected to the clutch housing 624. The friction discs 627 along their inner diameter are spline to a clutch hub 628. The first input gear 620 meshes with a first output gear 630. The third input gear 622 meshes with a third output gear 632. The output gears 630 and 632 are mounted by needle bearings on an output shaft 634. To torsionally connect the output shaft 634 with a remainder of the drive train of the vehicle (rear differential), the output shaft 634 has an output hub 636 that connects with a prop shaft (not shown). (Note in FIG. 8, the input shaft 610 and output shaft 634 are shown in a common horizontal plane for purposes of illustration only; in many applications, their axes vary in elevation).

The input shaft 610 also has an integrally formed second input gear 644. The second input gear 644 meshes with a second output gear 646. The second output gear 646 is rotatably mounted on the output shaft 634 and can be torsionally connected with the output shaft 634 via a second gear clutch housing 648 which interacts with a dry friction pack 650 and an inner hub 652 which upon activation of the friction pack 650 torsionally connects the second output gear 646 with the output shaft 634. The friction pack 650 is on an extreme end of the output shaft opposite of friction pack 626.

A first third gear synchronizer 654 is provided for selectively connecting the first output gear 630 or the third output gear 632 with the output shaft 634.

The first third gear clutch which includes clutch housing 624, friction pack 626 and hub 628, has a spring member 660 which causes the friction pack 626 to be normally engaged (closed) thereby causing the outer shaft 618 to be torsionally connected with the input shaft 610 during normal stages of operation. A hydraulically powered actuator 663 upon activation causes the friction pack 626 to be released thereby opening the normally closed friction pack 626. In an opposite manner, the clutch for the second gear which includes clutch housing 648, friction pack 650 and hub 652 is biased to a normally open position unless acted upon by actuator 666 to engage the second friction pack 650 to connect the second output gear 646 with the output shaft 634. To shift second gear from first or third gear actuator 663 releases friction pack 626 to disconnect the outer shaft 618 from the input shaft 610. Thereafter or simultaneously the actuator 666 is actuated to engage the friction pack 650 to torsionally connect the second output gear 646 with the output shaft 634. Thereafter, torsional force flows from the input shaft 610 through second input gear 644 through second output gear 646 to the output shaft 634 and hub 636. To provide a parking brake function, all that is needed is the actuation of the second dutch friction pack 650 while the first clutch is left in its normally closed state.

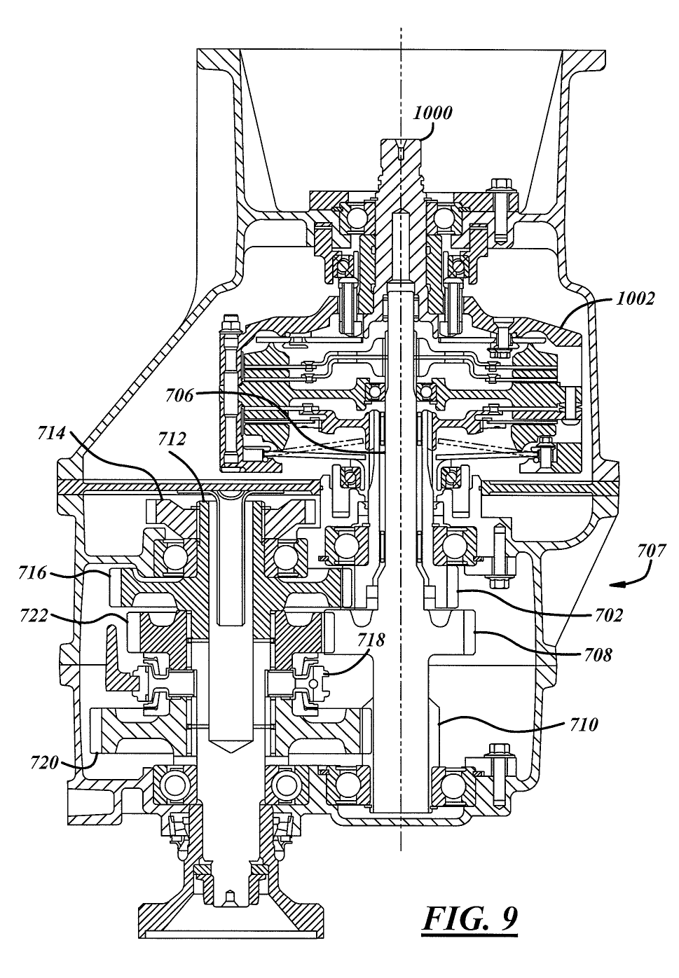

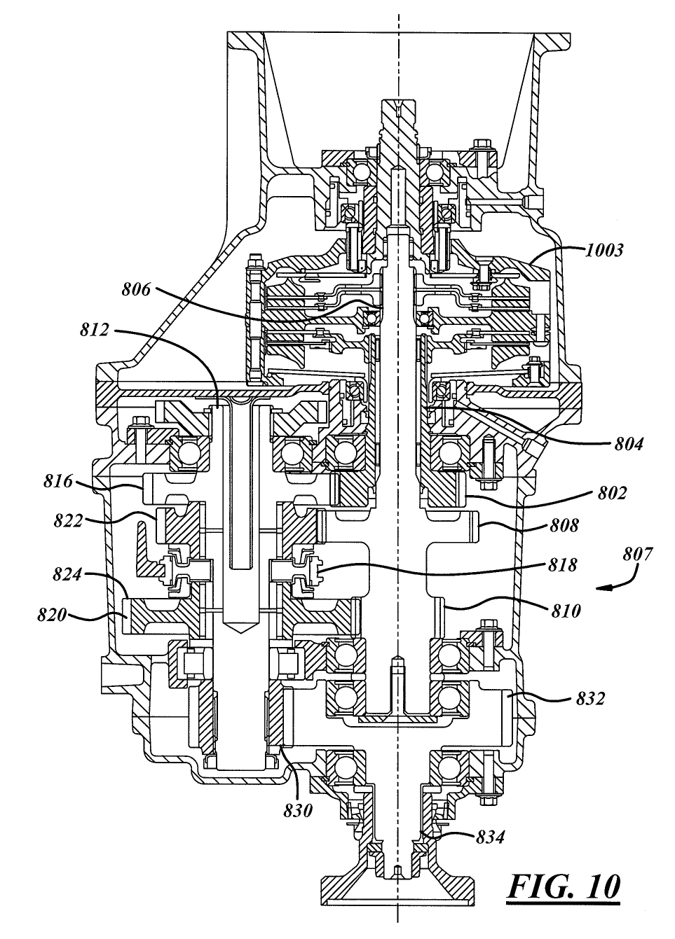

Referring to FIG. 9, a rear wheel drive transmission 702 for a three speed electric vehicle is provided which has an input shaft 1000 which powers a dual clutch 1002. The function of clutch 1002 will be described in greater detail later. Dual clutch 1002 selectively powers an outer input shaft 704 which is in turn connected with second input gear 702. Dual clutch 1002 also powers an inner input shaft 706 which is integrally connected with a third input gear 708 and a first input gear 710. Transmission 702 also has a counter or output shaft 712 which has torsionally connected thereto a parking brake gear 714. Output shaft 712 has a fixably connected second output gear 716. A first third gear synchronizer 718 is provided to selectively connect with the output gear 712, a first output gear 720, or a third output gear 722. Output shaft 712 is connected with a prop shaft (not shown) which is in turn connected with the rear wheel drive differential (not shown). Transmission 707 allows the inner and outer input shaft clutches to share a common housing.

Transmission 807 is a dual clutch rear wheel transmission for an electric vehicle. Transmission 807 has a dual clutch 1003 essentially similar in design and function to that of dual clutch 1002 previously mentioned. Transmission 807 has a first inner input shaft 806 which powers a first input gear 810 and a third input gear 808. An outer input shaft 804 powers a second input gear 802. A counter shaft 812 is provided. Counter shaft 812 is fixably connected with second output gear 816. A first third synchronizer 818 selectively connects first output gear 820 or third output gear 822 with counter shaft 812. Fixably connected towards a rearward end of the counter shaft 812 is an output gear 830. Output gear 830 is meshed with a second output gear 832 which has the same rotational axis as the inner input shaft 806 and outer input shaft 804. Second output gear 832 is integral with an output shaft 834 which is in turn torsionally connected with a prop shaft going to a rear differential of the vehicle. Transmission 807 is advantageous in that its output is axially aligned with the input to its dual dutch 1003.

Referring to FIG. 11, transmission 907 is provided. Transmission 907 has a dual dutch 1003 that selectively powers an outer input shaft 908 or an inner input shaft 910. Outer input shaft 908 is integrally connected with a second input gear 912 which is in turn meshed with a second output gear 914 which is integrally formed by a counter shaft 916. Transmission 907 also has a first input gear 918 which is meshed with a third output gear 920. Gear 920 is torsionally affixed to shaft 916. An output gear 922 is affixed to the end of shaft 916. Gear 922 is meshed with gear 924 which is fixably connected with output shaft 926. A first third gear synchronizer 928 selectively connects gear 918 with the inner input shaft 910 or connects output gear 924 with the inner input shaft 910. Accordingly, when second gear is desired, clutch 103 will be released from input shaft 910 and will be connected with the outer input shaft 908 allowing gear 912 to mesh with gear 914 causing gear 922 to mesh with gear 924 which in turn is connected with output shaft 926. For first gear ratio operation, clutch 1003 will actuate the inner input shaft 910 and will be released from the outer input shaft 908. Synchronizer 928 connects gear 918, directing torque to gears 922 and 924. For third gear operation synchronizer 928 connects gear 924 and shaft 926 for direct connection or direct drive to input shaft 910 allowing direct drive operation for third gear. Transmission 907 is also advantageous with respect to transmission 807 in that a gear set is eliminated while still retaining an output that is axially aligned with the input shaft of the transmission.

FIGS. 12 thru 19 provide enlarged views of the dual clutch 1003 shown in FIG. 11. Dual clutch 1003 has certain features which optimize its use in a dual clutch transmission for an electric vehicle. Clutch 1003 has an aluminum casing to save weight including a front housing 1020 and a rear housing 1022. The front housing 1020 and rear housing 1022 are connected together by a series of geometrically spaced bolts 1024. To save weight and energy, the front housing 1020 and rear housing 1022 are typically fabricated from cast aluminum. The front housing 1020 has a neck 1026. The neck 1026 has an inner diameter 1028. The clutch has a male input shaft 1032 (see FIG. 11). The male input shaft 1032 is typically fabricated from steel and along its outer diameter 1034 has a series of metal serrations. These metal serrations are pressed into the inner diameter 1028 of the neck 1026 and form corresponding female serrations in the neck inner diameter 1028. Clutch 1003 has a first clutch which includes hubs 1040 and 1042 for connection on input shaft 910. As mentioned previously, input shaft 910 is the input shaft for the first and third gears. Hub 1040 is operatively associated with friction disc 1044 and hub 1042 is operatively associated with friction disc 1046. The hubs 1040 and 1042 are typically fabricated from steel. On a forward side friction disc 1044 is a pressure plate 1048. Between the friction disc 1044 and 1046 is another pressure plate 1050. Rearward of the friction disc 1046 is a central pressure plate 1055. To engage the friction disc 1044 and 1046 with the pressure plates 1048, 1050 and 1052, there is provided a diaphragm 1054. The diaphragm 1054 adjacent its outer periphery pivots about a fulcrum 1070 which is held in position by a bolt 1072. The diaphragm 1054 is normally engaging with the pressure plate 1048 to apply the clutch for the inner diameter input shaft 910. To release the clutch for the inner diameter, a series of push rods 1056 which are controlled by a stationary piston 1060 (see FIG. 11) contact the diaphragm along the inner portion of the diaphragm urging the diaphragm outer end 1062 forwardly to relieve or disengage the clutch. Pressure plate 1048 and 1050 have lugs 1064 and 1066 respectively which abut a bridge 1068 of the clutch front housing to ensure that the pressure plates rotate with the housing. The central pressure plate 1052 is penetrated by the bolt 1024 to ensure its rotation with the front and rear housing 1020 and 1022 of the clutch.

The generally open clutch for the transmission outer input shaft 908 (FIG. 11) includes a hub 1074. Hub 1074 mounts friction disc 1076 which is axially fixed thereto. Additionally, hub 1074 mounts friction disc 1080. Friction disc 1080 has limited axial movement with respect to hub 1074. Between the friction disc 1076 and 1080 is a pressure plate 1082 which has a lug 1084 which abuts a bridge 1086 of the rear housing. The outer diameter shaft clutch also has a backing plate 1087 with lugs 1088 which also abut the bridge 1086 to keep the pressure plate 1087 from rotating. The rear casing 1022 mounts a rear diaphragm 1091. In normal operation, the dutch for the outer shaft is not engaged. When it is desired to engage the outer shaft dutch, a piston 1092 (FIG. 11) is actuated against one of the fingers 1093 of the diaphragm pushing against pressure plate 0187 to capture friction disc 1080, pressure plate 1082 and friction disc 1076 with the central pressure plate 1052 to thereby transfer torsional energy from the dutch to the outer input shaft 912. To release the dutch for the outer input shaft 912, the piston 1092 is deactivated. To minimize any drag which the clutch for the outer input shaft can cause during operation (which is critical for an electrically driven engine), a post 1094 is provided. The post has encircling between it and the central pressure plate 1052 a coil spring 1095. A head of the post 1094 in combination with the spring 1095 provides a stop to ensure that the pressure plate 1087 is pushed back to a minimum distance from the central pressure plate 1052 to minimize any potential drag that can occur when the hub 1074 is rotating and wherein it is desired that the clutch for the outer input shaft not be engaged. The axial floating nature of friction disc 1080 upon the hub 1074 also helps to contribute to a minimum of drag forces being induced. The dutch 1003 also has a headed post 1098 which penetrates the pressure plate 1082 and captures between the pressure plate spring washers 1099. Spring washers 1099 perform a function similar to that previously described for spring 1095 to ensure that pressure plate 1082 comes to a minimum distance away from central pressure plate 1052 to minimize any possible drag of the pressure plate 1082 with friction disc 1076 or friction disc 1080.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A three speed dual clutch transmission for an electrically powered automotive vehicle comprising:
a first shaft for receiving torsional energy from an electric motor;
a second shaft powered from the first shaft, said second shaft being torsionally connected with a vehicle differential;
a first normally dosed clutch for powering first and third gear sets;
a second normally open clutch for powering a second gear set; and
a synchronizer rotatably mounted on one of said first or second shafts for selectively torsionally connecting said first gear set or said third gear set with said second shaft.

2. A transmission as described in claim 1 for a transverse mounted motor powered vehicle.

3. A transmission as described in claim 1 for a rear wheel drive electric vehicle.

4. A three speed dual clutch transmission for an electrically powered automotive vehicle comprising:
an input shaft for receiving torsional energy from an electric motor;
an output shaft powered from said input shaft, said output shaft being torsionally connected with a vehicle differential;
a first normally closed clutch for powering first and third input gears;
a second normally open clutch for powering a second gear; and
a synchronizer rotatably mounted on said output shaft for selectively torsionally connecting said first or third output gears with said output shaft.

5. A transmission as described in claim 4 wherein at least one of said first and second clutches is a dry clutch.

6. A transmission as described in claim 4 wherein said input and output shafts are transverse mounted within the automotive vehicle.

7. A transmission as described in claim 4 wherein said first clutch has a rotational axis coterminous with the rotational axis of the motor powering said transmission.

8. A transmission as described in claim 4 wherein said second clutch rotates on said output shaft.

9. A transmission as described in claim 4 wherein said second clutch rotates on said input shaft.

10. A transmission as described in claim 4 wherein said first and second clutches rotate on a common axis.

11. A transmission as described in claim 10 wherein said first and second clutches rotate on an axis coterminous with an output axis of the motor powering said transmission.

12. A transmission as described in claim 10 wherein said first, second and third gears are on a common side of said first and second clutches.

13. A transmission as described in claim 10 wherein said first and second gears are on a separate side of said first and second clutches than said second gear.

14. A transmission as described in claim 10 wherein said first and second clutches share a common rotative housing.

15. A transmission as described in claim 4 wherein said first dutch is at an extreme end of said input shaft and said second dutch is on an opposite extreme end of said output shaft.

16. A transmission as described in claim 3 wherein said output shaft for said transmission is axially aligned with said input shaft of said transmission.

17. A transmission as described in claim 3 wherein said synchronizer for said first and second gear sets is axially aligned with said first shaft.

18. A transmission as described in claim 3 wherein said first and second clutch share a common housing and wherein a pressure plate for said normally open clutch is spring biased to a stop to prevent drag in said second clutch when said second clutch is not engaged.

19. A transmission as described in claim 18 wherein said housing is aluminum and wherein a clutch has a male input shaft with serrations forming serrations into said aluminum portion of said housing.

20. A transmission as described in claim 3 having at least one gear ratio being direct driven and said transmission has an output axially aligned with said input.

21. A clutch for a dual clutch transmission comprising:
a clutch housing for connection with an input shaft, said clutch housing having a central pressure plate;
a first hub connected with a friction disc for a normally engaged clutch for driving a first shaft;
a first axially moveable pressure plate for capturing said first disc with said first pressure plate to drive said first shaft;
a second hub connected with a friction disc for a normally non-engaged dutch for driving a second shaft; and
a second axially moveable pressure plate for capturing said second friction disc with said central pressure plate to drive said second shaft, said second pressure plate being biased to a non-engaged position with said section second friction disc to prevent drag when said second clutch is not engaged.

22. A dutch housing as described in claim 21 wherein said housing is aluminum and an input shaft of said clutch is steel.

23. A clutch as described in claim 22 wherein said second hub is axially moveable with respect to a second friction disc operatively associated with said hub.
